(19) United States
(12) Patent Application Publication
(10) Pub. No.: US 2009/0251267 A1
(43) Pub. Date: Oct. 8, 2009

(54) Inductors and methods of operating inductors

(75) Inventors: Dae-young Jeon, Mokpo-si (KR); Dong-chul Kim, Suwon-si (KR); Sun ae Seo, Hwaseong-si (KR); Ran-ju Jung, Seongnam-si (KR); Yun-sung Woo, Suwon-si (KR); Hyun-jong Chung, Hwaseong-si (KR)

Correspondence Address: HARNESS, DICKEY & PIERCE, P.L.C., P.O. BOX 8910, RESTON, VA, 20195, US

(73) Assignee: Samsung Electronics Co., Ltd.

(21) Appl. No.: 12/289,496

(22) Filed: Oct. 29, 2008

(30) Foreign Application Priority Data
Apr. 4, 2008 (KR) 10-2008-0031714

(51) Int. Cl. H01F 5/00

(52) U.S. Cl. 336/200

(57) ABSTRACT

An inductor may include a conductive line including a material in which an electrical resistance varies depending on an electric field applied to the material and/or first and second electrodes electrically connected to first and second end portions of the conductive line, respectively. A method of operating an inductor may include applying current to a conductive line of the inductor. The conductive line may include a material in which an electrical resistance may vary depending on an electric field applied to the material. The current may be applied to the conductive line via first and second electrodes electrically connected to first and second end portions of the conductive line, respectively.

### PRIORITY STATEMENT

This application claims priority from Korean Patent Application No. 10-2008-0031714, filed on Apr. 4, 2008, in the Korean Intellectual Property Office (KIPO), the entire contents of which are incorporated herein by reference.

### BACKGROUND

1. Field

Example embodiments relate to electric devices. Also, example embodiments relate to inductors and methods of operating the same.

2. Description of Related Art

Inductors are a kind of passive device and are important devices in most electronic circuits. In particular, in radio frequency (RF) application circuits, in addition to capacitors, inductors are used in almost all filters.

As such, inductors may be used in most electronic circuits, and thus, the inductors may need to be small in order to obtain highly integrated circuits. However, it may be difficult to make the inductors small and/or have a high performance as compared to other passive devices, such as capacitors or resistors.

In the case of a copper (Cu) inductor, even if the Cu inductor may have a line width of about several μm, the resistance of the Cu inductor may increase relative to self-inductance of the Cu inductor, and thereby, may decrease a quality factor of the Cu inductor.

When an inductor is manufactured using a carbon nanotube (CNT), there may be many problems in manufacturing the inductor. For example, it may be difficult to ensure uniformity and/or reproductivity during a CNT composition process and/or to arrange the composited CNT in a desired position of a substrate. Accordingly, it may be difficult to apply a CNT inductor to a real circuit.

On the other hand, in the case of an inductor using an operational amplifier, the structure of the inductor may be complicated, and thus it may be difficult to form the inductor.

### SUMMARY

Example embodiments may provide inductors and methods of operating the same.

According to example embodiments, an inductor may include a conductive line, a first electrode, and/or a second electrode. The conductive line may include a material in which an electrical resistance varies depending on an electric field applied to the material. The first electrode may be electrically connected to a first end portion of the conductive line. The second electrode may be electrically connected to a second end portion of the conductive line.

According to example embodiments, the material may comprise graphene.

According to example embodiments, the inductor may further comprise means for applying the electric field to the conductive line. The means may comprise a conductor spaced apart from the conductive line.

According to example embodiments, the inductor may further comprise an insulating layer between the conductive line and the conductor.

According to example embodiments, the conductive line may be a meander type, a spiral type, or a loop type.

According to example embodiments, the inductor may further comprise a conductor spaced apart from the conductive line.

According to example embodiments, the conductor may be configured to apply the electric field to the conductive line.

According to example embodiments, the inductor may further comprise an insulating layer between the conductive line and the conductor.

According to example embodiments, increasing a magnitude of the electric field may increase the electrical resistance of the material. In addition or in the alternative, increasing the magnitude of the electric field may decrease an electrical resistance of the conductive line. In addition or in the alternative, increasing the magnitude of the electric field may decrease a quality factor of the inductor.

According to example embodiments, a method of operating an inductor that includes a conductive line comprising a material in which an electrical resistance varies depending on an electric field applied to the material, a first electrode electrically connected to a first end portion of the conductive line, and/or a second electrode electrically connected to a second end portion of the conductive line, may include applying current to the conductive line.

According to example embodiments, the material may comprise graphene.

According to example embodiments, the inductor may further comprise means for applying the electric field to the conductive line. The means may comprise a conductor spaced apart from the conductive line. The means may further comprise an insulating layer between the conductive line and the conductor.

According to example embodiments, the current may be applied to the conductive line while applying the electric field to the conductive line using the means for applying the electric field.

According to example embodiments, the conductive line may be a meander type, a spiral type, or a loop type.

According to example embodiments, the inductor may further include a conductor spaced apart from the conductive line; or a conductor spaced apart from the conductive line and an insulating layer between the conductive line and the conductor.

### BRIEF DESCRIPTION OF THE DRAWINGS

The above and/or other aspects and advantages will become more apparent and more readily appreciated from the following detailed description of example embodiments taken in conjunction with the accompanying drawings, in which:

FIG. 1 is a perspective view of an inductor according to example embodiments;

FIGS. 2 and 3 are plan views of conductive lines that may be included in inductors according to example embodiments;

FIG. 4A illustrates an equivalent circuit model, including an inductor, according to example embodiments;

FIG. 4B is a graph illustrating a frequency response characteristic that may depend on a magnitude of an electric field applied to a conductive line of the inductor in the equivalent circuit model of FIG. 4A; and

FIGS. 5A through 5D are perspective views illustrating a method of manufacturing an inductor according to example embodiments.

### DETAILED DESCRIPTION OF EXAMPLE EMBODIMENTS

Example embodiments will now be described more fully with reference to the accompanying drawings. Embodiments, however, may be embodied in many different forms and should not be construed as being limited to the embodiments set forth herein. Rather, these example embodiments are provided so that this disclosure will be thorough and complete, and will fully convey the scope to those skilled in the art. In the drawings, the thicknesses of layers and regions are exaggerated for clarity.

It will be understood that when an element is referred to as being “on,” “connected to,” “electrically connected to,” or “coupled to” to another component, it may be directly on, connected to, electrically connected to, or coupled to the other component or intervening components may be present. In contrast, when a component is referred to as being “directly on,” “directly connected to,” “directly electrically connected to,” or “directly coupled to” another component, there are no intervening components present. As used herein, the term “and/or” includes any and all combinations of one or more of the associated listed items.

It will be understood that although the terms first, second, third, etc., may be used herein to describe various elements, components, regions, layers, and/or sections, these elements, components, regions, layers, and/or sections should not be limited by these terms. These terms are only used to distinguish one element, component, region, layer, and/or section from another element, component, region, layer, and/or section. For example, a first element, component, region, layer, and/or section could be termed a second element, component, region, layer, and/or section without departing from the teachings of example embodiments.

Spatially relative terms, such as “beneath,” “below,” “lower,” “above,” “upper,” and the like may be used herein for ease of description to describe the relationship of one component and/or feature to another component and/or feature, or other component(s) and/or feature(s), as illustrated in the drawings. It will be understood that the spatially relative terms are intended to encompass different orientations of the device in use or operation in addition to the orientation depicted in the figures.

The terminology used herein is for the purpose of describing particular example embodiments only and is not intended to be limiting. As used herein, the singular forms “a,” “an,” and “the” are intended to include the plural forms as well, unless the context clearly indicates otherwise. It will be further understood that the terms “comprises,” “comprising,” “includes,” and/or “including,” when used in this specification, specify the presence of stated features, integers, steps, operations, elements, and/or components, but do not preclude the presence or addition of one or more other features, integers, steps, operations, elements, and/or components.

Unless otherwise defined, all terms (including technical and scientific terms) used herein have the same meaning as commonly understood by one of ordinary skill in the art to which example embodiments belong. It will be further understood that terms, such as those defined in commonly used dictionaries, should be interpreted as having a meaning that is consistent with their meaning in the context of the relevant art and should not be interpreted in an idealized or overly formal sense unless expressly so defined herein.

Reference will now be made to example embodiments, which are illustrated in the accompanying drawings, wherein like reference numerals may refer to like components throughout.

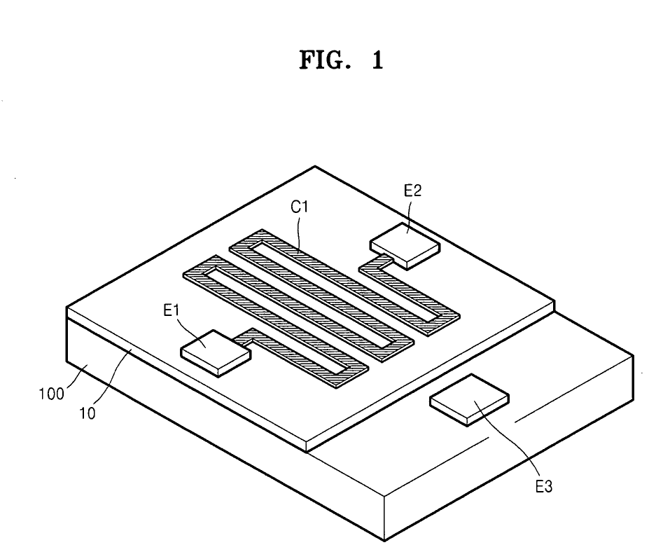

FIG. 1 is a perspective view of an inductor according to example embodiments.

Referring to FIG. 1, a conductive line C1 for the inductor may be formed on an insulating layer 10. The conductive line C1 may have a nano-scale line width, that is, in the range from about several nanometers (nm) to about several hundred nanometers. The conductive line C1 may be a meander type (e.g., having one or more curves or turns). However, the shape of the conductive line C1 may vary. According to example embodiments, the conductive line C1 may have at least one graphene (described later).

First and second electrodes E1 and E2 may be electrically connected to end portions of the conductive line C1. The first and second electrodes E1 and E2 may be directly connected to the end portions of the conductive line C1 on the insulating layer 10. However, the first and second electrodes E1 and E2 may be indirectly connected to one or both end portions of the conductive line C1, for example, through a conductive plug and/or wiring. If the conductive line C1 is a meander type, it may have for example, one or more curves or turns such that one or more portions of the conductive line C1 lie on both sides of a line segment drawn between the first and second electrodes E1 and E2.

A conductor 100, for applying an electric field to the conductive line C1, may be formed so as to be spaced apart from the conductive line C1. The conductor 100 may have a layer shape, may be formed below the insulating layer 10, and/or may be extended on at least one side of the insulating layer 10. A third electrode E3 may be formed on a part of the conductor 100 on which the insulating layer 10 is not formed.

The conductor 100 may be a part of a substrate, for example, a silicon substrate, and may be a region in which or on which conductive impurities are doped with high concentration. The structure and/or position of the conductor 100 are not limited to those discussed above and may vary. For example, the conductor 100 may be disposed above the conductive line C1. In another example, the conductor 100 may be formed of metal. In yet another example, the conductor 100 may have a multi-layer structure. In example embodiments, the inductor may not include third electrode E3. In example embodiments, the inductor may not include conductor 100. In example embodiments, the conductive line C1 may be formed of one or more materials having electrical characteristics similar to that of graphene.

Example embodiments of the graphene of the conductive line C1 are be described below.

A graphene is a single-layer structure formed of carbon, having an electrical characteristic similar to that of a carbon nanotube (CNT), and a 2-dimensional ballistic transport characteristic. The 2-dimensional ballistic transport of charges in a material means that the charges move with negligible electrical resistivity due to scattering. Therefore, a graphene may have very low electrical resistance even though the graphene has a sub-micron size. Since a quality factor (Q) for an inductor (at a given frequency) may be obtained by dividing its inductive reactance (ωL) by its electrical resistance (R), an inductor having a high quality factor may be realized even using graphene having a small size.

Also, graphene may be formed more easily than CNT. For example, typically CNT should be formed on a first substrate and then moved to a second substrate for manufacturing devices. In contrast, graphene may be directly formed on a substrate for manufacturing devices. That is, a plate-shaped graphene may be formed on the substrate for manufacturing devices, and then, the graphene may be patterned as desired. The graphene may be etched using O₂ plasma, and thus, a fine graphene pattern having a desired pattern may be obtained by using a top-down process, such as photolithography or E-beam lithography. Therefore, when inductors are manufactured using graphenes, problems due to misalignments may be prevented or minimized. Also, the uniformity and/or reproductivity of the inductors may be improved.

In addition, graphene has a general semi-metal characteristic, and a unique characteristic in that its electrical resistance may vary with an electric field applied from the outside. Accordingly, an inductor capable of adjusting a quality factor may be realized using graphene. In FIG. 1, the conductor 100 may provide, for example, a means for applying an electric field to the conductive line C1. When an electric field is applied from the conductor 100 to the conductive line C1 by applying a voltage to the conductor 100, current may be applied to the conductive line C1 through the first and the second electrodes E1 and E2. A magnitude of the electric field applied from the conductor 100 to the conductive line C1 may be controlled depending on a magnitude of the voltage that is applied to the conductor 100, and the electrical resistance of the conductive line C1 may vary depending on the magnitude of the electric field. Thus, the quality factor of the inductor may be controlled.

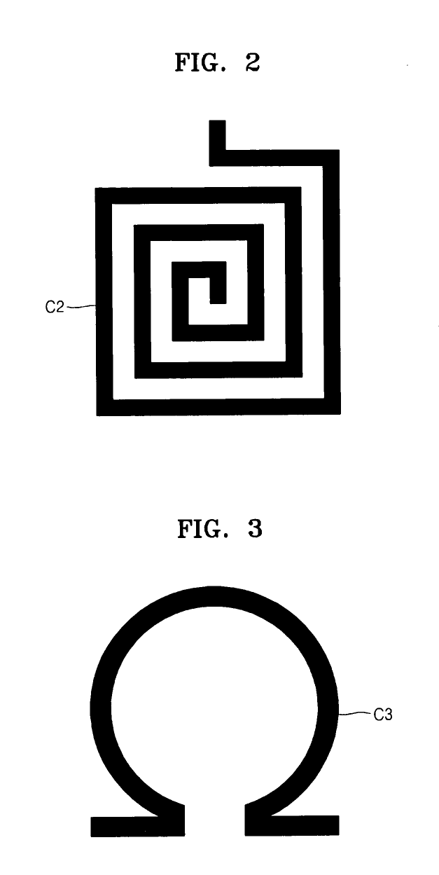

The conductive line C1 of FIG. 1 may have various shapes as illustrated, for example, in FIGS. 2 and 3. FIGS. 2 and 3 are plan views of conductive lines that may be included in inductors according to example embodiments. Referring to FIGS. 2 and 3, conductive lines C2 and C3 may respectively be a spiral type and/or a loop type. One of ordinary skill in the art will understand that other shapes may be included, in addition to or in the alternative to, these shapes.

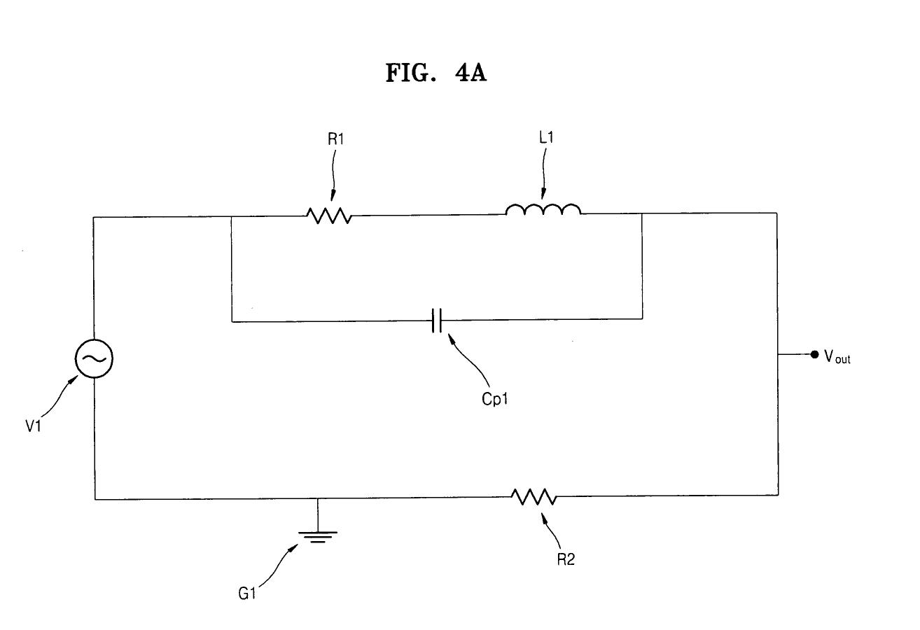

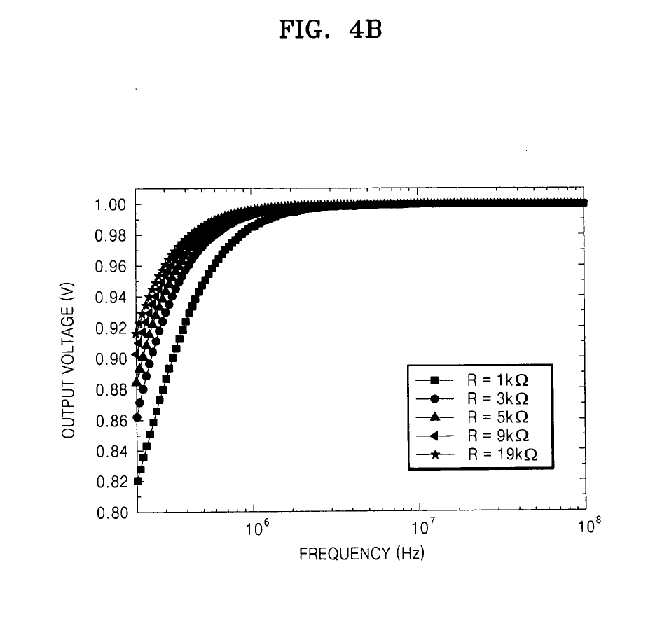

FIG. 4A illustrates an equivalent circuit model, including an inductor, according to example embodiments. FIG. 4B is a graph illustrating a frequency response characteristic that may depend on a magnitude of an electric field applied to a conductive line of the inductor in the equivalent circuit model of FIG. 4A.

Referring to FIG. 4A, the inductor according to example embodiments may include an inductor component L1, a resistance component R1, and/or a parasitic capacitor component Cp1. The inductor component L1 and the resistance component R1 may be connected in series to each other. The parasitic capacitor component Cp1 may be connected in parallel to the inductor component L1 and/or the resistance component R1. In FIG. 4A, the equivalent circuit model further may include a voltage generator V1 and/or a load resistor R2. In FIG. 4A, G1 and Vₒᵤₜ denote a ground and an output terminal, respectively.

FIG. 4B illustrates a frequency response characteristic of the equivalent circuit of FIG. 4A, when the electrical resistance of the inductor is changed from about 1 kΩ (kiloohm) to about 19 kΩ by an electric field in the equivalent circuit of FIG. 4A. Here, it may be assumed that an inductance of the inductor component L1 is about 1 μH (microhenry) and a capacitance of the parasitic capacitor component Cp1 is about 1 nF (nanofarad).

Referring to FIG. 4B, as the electrical resistance of the inductor decreases, the output voltage also may decrease for frequencies less than about 10⁶ Hz (Hertz) (as would be understood by one of ordinary skill in the art, this frequency value may depend, for example, on the structure, size, and/or other characteristics of the inductor). As the frequency decreases, this effect may or may not be more pronounced. Thus, as the electrical resistance of the inductor varies, the quality factor of the inductor may vary. For example, as the electrical resistance of the inductor increases at a given frequency, the quality factor of the inductor may decrease.

In example embodiments, increasing the magnitude of the voltage applied to the conductor 100 may increase the magnitude of the electric field applied from the conductor 100 to the conductive line C1; increasing the magnitude of the electric field applied from the conductor 100 to the conductive line C1 may increase, decrease, or leave unchanged the resistance of conductive line C1 (as would be understood by one of ordinary skill in the art, this effect may depend, for example, on the position of a Dirac point of conductive line C1); and/or increasing the resistance of conductive line C1 may decrease the quality factor of the inductor.

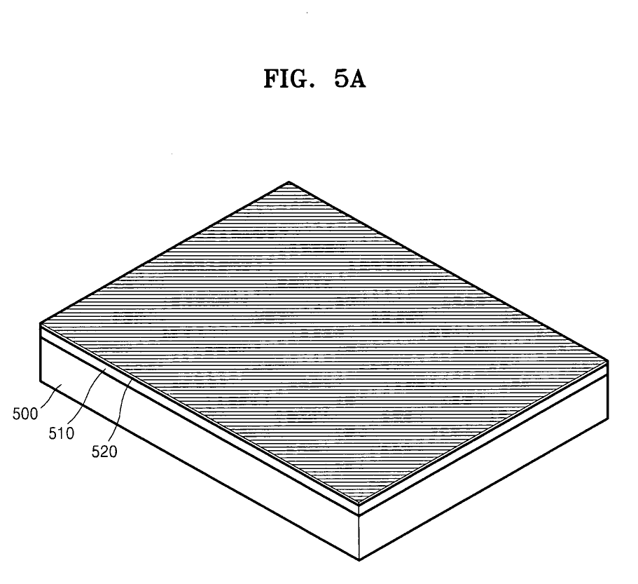

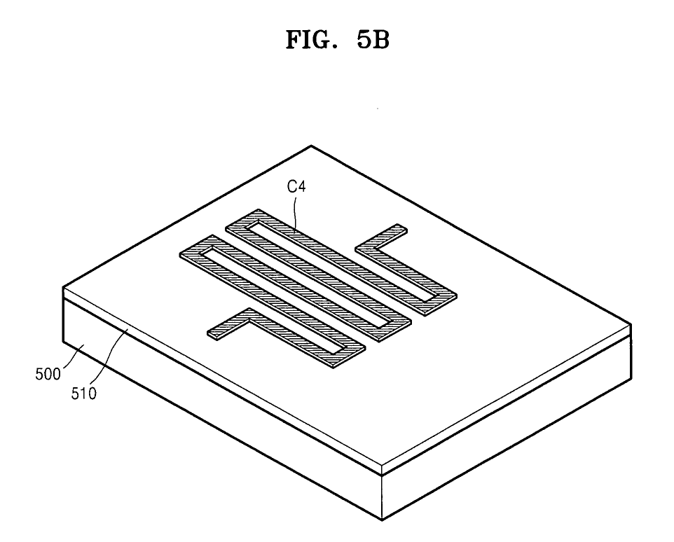

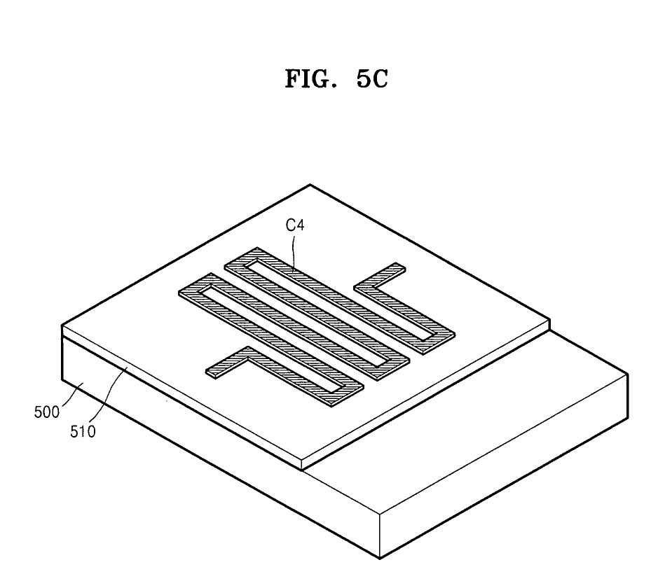

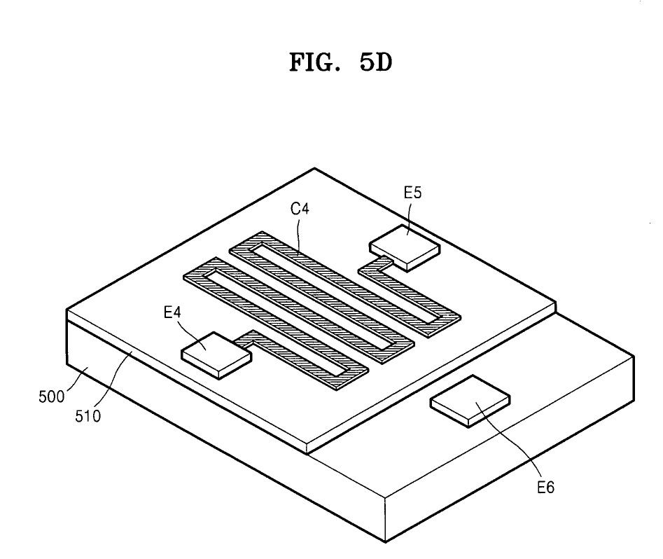

FIGS. 5A through 5D are perspective views illustrating a method of manufacturing an inductor according to example embodiments.

Referring to FIG. 5A, an insulating layer 510 may be formed on a conductor 500, and a conductive layer 520 may be formed on the insulating layer 510. However, the conductor 500, the insulating layer 510, and the conductive layer 520 may be formed in any order. The conductor 500 may be a part of a substrate and/or may be a region doped with conductive impurities having high concentration, but the example embodiments are not limited those particular embodiments. The conductive layer 520 may include at least one graphene that may be formed, for example, using a growth method and/or an exfoliation method. For example, the graphene may be grown on a SiC substrate or on a buffer layer that is formed on a Si substrate. When the graphene is formed using the exfoliation method, a single crystal graphite may be used. For example, if the single crystal graphite is bonded to an upper surface of the insulating layer 510, a Van der Waals' force may act between the insulating layer 510 and the single crystal graphite, and accordingly, several to several hundreds of graphenes may be attached to an upper surface of the insulating layer 510. Methods of forming the conductive layer 520 are not limited to those particular embodiments.

The conductive layer 520 may be patterned. For example, the conductive layer 520 may be patterned using a conventional lithography method. When the conductive layer 520 includes graphene, the conductive layer 520 may be etched using, for example, O₂ plasma. Also, when the conductive layer 520 is patterned using a fine patterning method such as an E-beam lithography method, the conductive layer 520 may be patterned in a nano scale. An example result of the patterning process is illustrated in FIG. 5B.

By removing a part of the insulating layer 510, on which the conductive line C4 is not formed, a part of the conductor 500 may be exposed, as illustrated in FIG. 5C. The timing for removing a part of the insulating layer 510 may vary, and under different conditions, a part of the insulating layer 510 may not be removed.

Referring to FIG. 5D, fourth and fifth electrodes E4 and E5 may be connected to end portions of the conductive line C4, and a sixth electrode E6, attached to an exposed upper surface of the conductor 500, may be formed. Although not shown in the drawing, before the fourth through sixth electrodes E4 through E6 are formed, an interlayer insulating layer may be formed on the conductive line C4, the insulating layer 510, and the exposed upper surface of the conductor 500, and then contact holes exposing the conductor 500 and/or the end portions of the conductive line C4 may be formed by etching portions of the interlayer insulating layer. In this case, electrodes connecting to the conductive plugs may be formed on the interlayer insulating layer. The electrodes may be formed, for example, after conductive plugs for plugging the contact holes are formed.

In example embodiments, the inductor may not include third electrode E6. In example embodiments, the inductor may not include conductor 500. In example embodiments, the conductive line C4 may be formed of one or more materials having electrical characteristics similar to that of graphene.

While example embodiments have been particularly shown and described, it will be understood by those of ordinary skill in the art that various changes in form and details may be made therein without departing from the spirit and scope of the present invention as defined by the following claims.

What is claimed is:

1. An inductor, comprising:
a conductive line comprising a material in which an electrical resistance varies depending on an electric field applied to the material; and
first and second electrodes electrically connected to first and second end portions of the conductive line, respectively.

2. The inductor of claim 1, wherein the material comprises graphene.

3. The inductor of claim 1, further comprising:
means for applying the electric field to the conductive line.

4. The inductor of claim 3, wherein the means comprises:
a conductor spaced apart from the conductive line.

5. The inductor of claim 4, further comprising:
an insulating layer between the conductive line and the conductor.

6. The inductor of claim 1, wherein the conductive line is a meander type, a spiral type, or a loop type.

7. The inductor of claim 1, further comprising:
a conductor spaced apart from the conductive line.

8. The inductor of claim 7, wherein the conductor is configured to apply the electric field to the conductive line.

9. The inductor of claim 7, further comprising:
an insulating layer between the conductive line and the conductor.

10. The inductor of claim 1, wherein increasing a magnitude of the electric field increases the electrical resistance of the material.

11. The inductor of claim 1, wherein increasing a magnitude of the electric field decreases an electrical resistance of the conductive line.

12. The inductor of claim 1, wherein increasing a magnitude of the electric field decreases a quality factor of the inductor.

13. A method of operating an inductor, the method comprising:
applying current to a conductive line of the inductor;
wherein the conductive line comprises a material in which an electrical resistance varies depending on an electric field applied to the material, and
wherein the current is applied to the conductive line via first and second electrodes electrically connected to first and second end portions of the conductive line, respectively.

14. The method of claim 13, wherein the material comprises graphene.

15. The method of claim 13, further comprising:
means for applying the electric field to the conductive line.

16. The method of claim 15, wherein the means comprises:
a conductor spaced apart from the conductive line.

17. The method of claim 16, wherein the means further comprises:
an insulating layer between the conductive line and the conductor.

18. The method of claim 15, wherein the current is applied to the conductive line while applying the electric field to the conductive line using the means for applying the electric field.

19. The method of claim 13, wherein the conductive line is a meander type, a spiral type, or a loop type.

20. The method of claim 13, wherein the inductor further includes:
a conductor spaced apart from the conductive line; or
a conductor spaced apart from the conductive line and an insulating layer between the conductive line and the conductor.
